(19) United States
(12) Patent Application Publication
(10) Pub. No.: US 2009/0061687 A1
(43) Pub. Date: Mar. 5, 2009

(54) CONNECTOR PLUG

(75) Inventor: Yukio Oya, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/186,153

(22) Filed: Aug. 5, 2008

(30) Foreign Application Priority Data
Aug. 29, 2007 (JP) 2007-222786

(51) Int. Cl. H01R 13/68

(52) U.S. Cl. 439/620.26

(57) ABSTRACT

According to one embodiment, a connector plug includes a plug housing, a head terminal movably attached to a distal end portion of the plug housing, a fixed terminal arranged in the plug housing and electrically connected to a power cord, a cartridge fuse located between the head terminal and the fixed terminal in the plug housing, and a connecting member located between the cartridge fuse and the fixed terminal. The connecting member has a spring portion, which is located between the cartridge fuse and the fixed terminal and urges the cartridge fuse toward the head terminal, and a continuation portion, which extends from an end of the spring portion on the cartridge fuse side, extends straight or in a curve, and is electrically connected to the power cord.

### CROSS-REFERENCE TO RELATED APPLICATIONS

This application is based upon and claims the benefit of priority from Japanese Patent Application No. 2007-222786, filed Aug. 29, 2007, the entire contents of which are incorporated herein by reference.

### BACKGROUND

1. Field

One embodiment of the present invention relates to a connector plug provided with a fuse as an overcurrent protection circuit, and more specifically, to a connector plug fitted and connected to, for example, a car cigar lighter socket and configured to supply electrical power to portable on-board equipment.

2. Description of the Related Art

In recent years, a large number of electronic devices for on-board use have been commercialized, including navigation devices, portable DVD drive units, communication equipment, etc. In addition, car battery plugs for extracting electrical power from a car cigar lighter socket are widely used for supplying power to these electronic devices.

As described in Jpn. Pat. Appln. KOKAI Publication No. 10-64632, for example, a car battery plug as a conventional connector plug is configured so that a cartridge fuse is interposed between a fixed terminal and a head terminal in contact with a power terminal of a car cigar lighter socket, for the purpose of protection against an overcurrent from the socket.

The conventional car battery plug is provided with a cylindrical plug housing, the head terminal movably arranged on the distal end portion of the plug housing, and the fixed terminal in the plug housing. The fixed terminal is electrically connected to a power-source lead wire of a power cord through a circuit board located in the plug housing.

In the plug housing, an electrically conductive spring portion and the cartridge fuse are mounted in series between the head terminal and the fixed terminal. The conductive spring portion can be compressed to urge the head terminal to project from the distal end portion of the plug housing. Thus, the head terminal is electrically connected to the power cord through the conductive spring portion, cartridge fuse, and fixed terminal, and the interposed cartridge fuse forms an overcurrent protection circuit.

If the car battery plug constructed in this manner is fitted into the car cigar lighter socket, the conductive spring portion is compressed so that the head terminal retreats in contact with the power terminal that is exposed on the inner bottom surface of the connector socket. Thereupon, the power terminal of the cigar lighter socket is connected to the power-source lead wire of the power cord by the car battery plug.

If an overcurrent then flows through the power terminal, the cartridge fuse blows to prevent the overcurrent from flowing into on-board electronic devices. The blown cartridge fuse can be removed from the plug housing and replaced.

In the conventional car battery plug described above, the current supplied from the power terminal of the cigar lighter socket flows through the head terminal, conductive spring portion, and fixed terminal. If the battery of any on-board electronic device is charged, therefore, a large amount of current sometimes may flow through the spring portion to heat it to high temperature. In this case, the entire car battery plug becomes so hot that it may possibly worry a user and adversely affect components around the spring portion.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a car battery plug according to an embodiment of the invention;

FIG. 2 is an exemplary exploded perspective view showing the car battery plug;

FIG. 3 is an exemplary plan view showing the internal structure of the car battery plug;

FIG. 4 is an exemplary longitudinal sectional view of the car battery plug;

FIG. 5 is an exemplary perspective view showing a printed circuit board, a connecting member, and a ground contact arranged in the car battery plug;

FIG. 6 is an exemplary enlarged perspective view showing the connecting member; and

FIG. 7 is an exemplary enlarged perspective view showing a connecting member according to another embodiment.

### DETAILED DESCRIPTION

Various embodiments according to the invention will be described hereinafter with reference to the accompanying drawings. In general, according to one embodiment of the invention, there is provided a connector plug comprising a plug housing attached to a power cord; a head terminal movably attached to a distal end portion of the plug housing; a fixed terminal arranged in the plug housing and electrically connected to the power cord; a cartridge fuse located between the head terminal and the fixed terminal in the plug housing; and a connecting member including a spring portion, which is wound like a coil spring and located between the cartridge fuse and the fixed terminal, urges the cartridge fuse toward the head terminal, and electrically connects the cartridge fuse and the fixed terminal, and a continuation portion, which extends from an end of the spring portion on the cartridge fuse side, extends straight or in a curve, and is electrically connected to the power cord.

An embodiment in which a connector plug of this invention is applied to a car battery plug will now be described in detail with reference to the accompanying drawings.

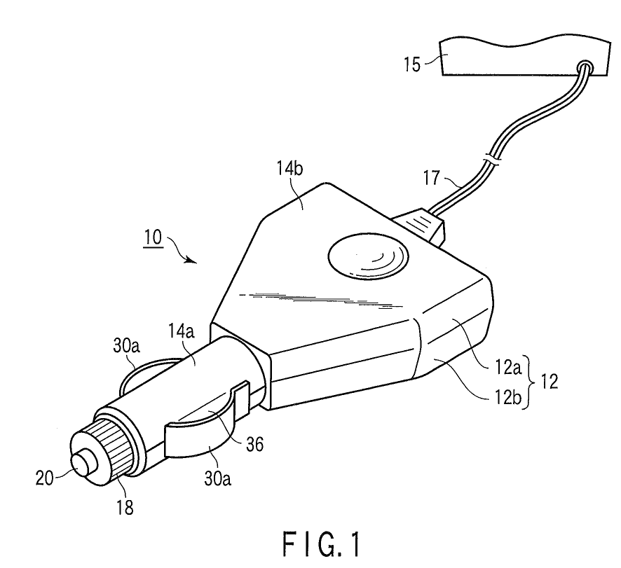

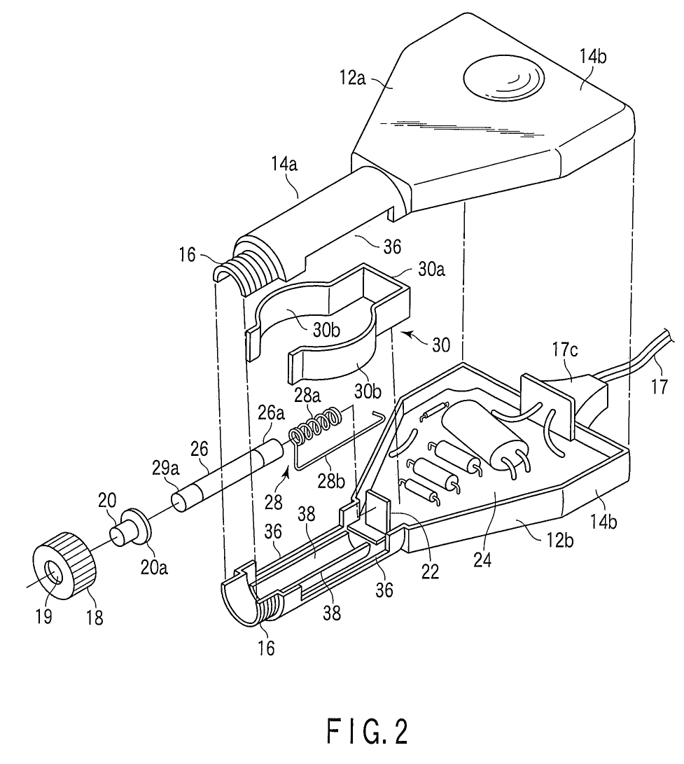

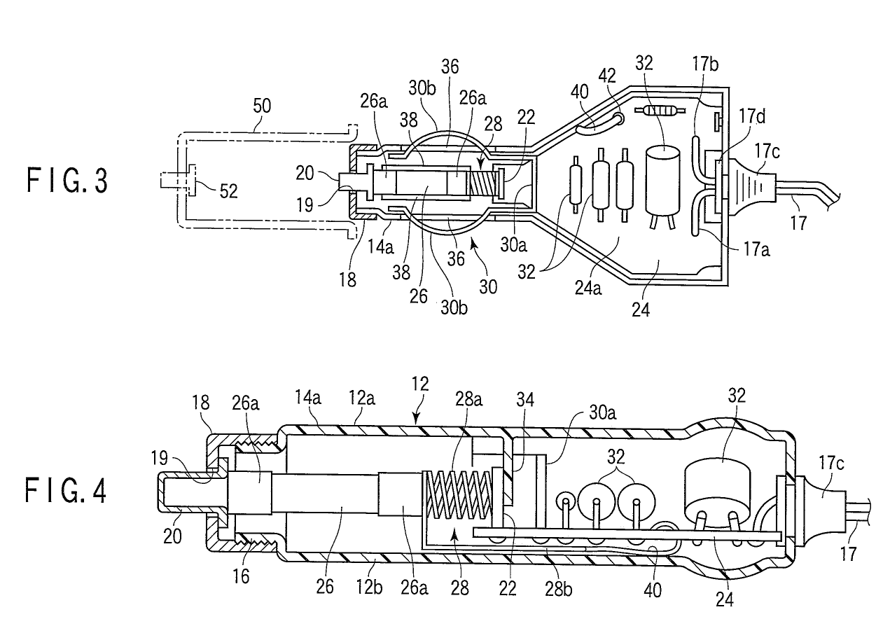

FIG. 1 is a perspective view showing an external appearance of a car battery plug 10, FIG. 2 is an exploded perspective view of the plug 10, FIG. 3 is a plan view showing the internal structure of the plug 10. As shown in FIGS. 1 and 2, the car battery plug 10 is provided with a plug housing 12 that is molded from an insulating synthetic resin. The plug housing is attached to an extended end of a power cord 17, which extends from an electronic device (not shown), e.g., a portable DVD drive unit 15.

The plug housing 12 is formed of an upper housing 12a and a lower housing 12b that are longitudinally divided and fitted together. These two housings 12a and 12b are combined in such a manner that engaging lugs (not shown) formed on their respective peripheral edge portions are engaged with one another and that an insulating cap (mentioned later) is screwed onto both of the housings. A space that accommodates various components is defined in the plug housing 12.

The distal end side of the plug housing 12 is formed as a cylindrical insertion portion 14a, while the rear end side forms a grip portion 14b that is configured to be held by a user. The grip portion 14b is wider than the insertion portion 14a. The insertion portion 14a has an outer diameter slightly smaller than the inner diameter of a cigar lighter socket 50 (see FIG. 3), so that the insertion portion can be inserted into the socket.

A thread portion 16 is formed on the outer periphery of the distal end of the insertion portion 14a. An insulating cap 18 is externally removably screwed onto the thread portion 16, thereby covering the distal end of the insertion portion 14a and connecting the upper and lower housings 12a and 12b to each other. The cap 18 is a bottomed cylinder of an insulating synthetic resin. A through-hole 19 is formed in the bottom wall of the cap 18. It is situated at the distal end of the insertion portion 14a so as to be coaxial with it.

As shown in FIGS. 2, 3 and 4, the plug housing 12 contains a head terminal 20, a printed circuit board (PCB) 24 mounted with a fixed terminal 22, a cartridge fuse 26, a connecting member 28, a ground contact 30, etc.

The head terminal 20 is a cylindrical structure molded from an electrically conductive metallic material. Its distal end portion is closed, and a circular flange 20a is formed on the other end portion. The terminal 20 is passed through the through-hole 19 from inside the insulating cap 18 and held for movement in the cap. The distal end portion of the head terminal 20 projects forward through the through-hole 19 and is prevented from slipping out of the insulating cap 18 by the flange 20a.

The PCB 24 is contained in the grip portion 14b of the plug housing 12. The PCB 24 is shaped so that its peripheral contour extends along the inner surface of the lower housing 12b. The PCB 24 is located in a predetermined position by a positioning boss (not shown) or the like that is formed on the inner surface of the lower housing 12b.

As shown in FIGS. 2, 3 and 5, a plurality of electronic components 32 are mounted on one surface, e.g., an upper surface 24a, of the PCB 24. A wiring pattern 24c is formed on a reverse surface 24b of the PCB 24 and electrically connected with the electronic components 32. Further, a power-source lead wire 17a and a ground lead wire 17b of the power cord 17, the ground contact 30, and the fixed terminal 22 are attached to the upper surface 24a of the PCB 24.

The terminal end of the power cord 17 is covered by a cord bush 17c of an insulating synthetic resin. A flange portion 17d of the bush 17c is fitted to the respective rear ends of the upper and lower housings 12a and 12b. The power-source lead wire 17a and the ground lead wire 17b that are led out from the terminal end are solder-connected to a power source pattern and a ground pattern (not shown), respectively, on the reverse surface 24b side of the PCB 24.

The fixed terminal 22 is a substantially rectangular, electrically conductive plate of, e.g., copper, which is set on the upper surface 24a of the PCB 24 perpendicularly to the upper surface. The fixed terminal 22 is fixed to the PCB 24 in such a manner that it partially penetrates the PCB 24 and is soldered to the power source pattern on the reverse surface 24b side. Thus, the fixed terminal 22 is electrically connected to the power-source lead wire 17a by the power source pattern. In the plug housing 12, moreover, the fixed terminal 22 is situated inside the proximal end portion of the insertion portion 14a and faces the head terminal 20 across a gap.

As will be described later, the fixed terminal 22 functions as a retainer of a spring portion and receives the urging force of the spring portion from the distal end side of the insertion portion 14a. As shown in FIG. 4, however, the fixed terminal 22 has its reverse side supported by a support lug 34 that is set substantially perpendicularly on the inner surface of the upper housing 12a, whereby it is prevented from falling backward.

As shown in FIGS. 1, 2, 3 and 5, the ground contact 30 is formed by bending an electrically conductive, elastic metal belt into a substantially U-shaped form. Specifically, the ground contact 30 includes a proximal portion 30a and a pair of contact portions 30b in the form of leaf springs individually extending forward (toward the distal end) from the opposite sides of the proximal portion 30a. The proximal portion 30a is set up vertically behind the fixed terminal 22 on the upper surface 24a of the PCB 24. The proximal portion 30a is fixed to the PCB 24 in such a manner that it partially penetrates the PCB 24 and is soldered to the ground pattern on the reverse surface 24b side. Thus, the ground contact 30 is electrically connected to the ground lead wire 17b by the ground pattern.

The pair of contact portions 30b are arcuately bent so as to individually bulge sideways and project outward through window holes 36 on the opposite sides of the insertion portion 14a of the plug housing 12. The width between the two contact portions 30b that project through the window holes 36 is a little greater than the inner diameter of the cigar lighter socket 50. The respective distal ends of the contact portions 30b are inserted into the insertion portion 14a and held in elastic engagement with the inner surface of the insertion portion. When the insertion portion 14a of the car battery plug 10 is fitted into the cigar lighter socket 50, the contact portions 30b elastically contact ground terminals on the inner surface of the lighter socket 50.

In the insertion portion 14a of the plug housing 12, as shown in FIGS. 2 to 4, the cartridge fuse 26 and the connecting member 28 are arranged in series with each other between the head terminal 20 and the fixed terminal 22. Specifically, the cartridge fuse 26 is a cylinder that has terminal areas 26a on its opposite end portions, individually. A plurality of guide ribs 38 are formed on the inner surface of the insertion portion 14a so as to extend axially of the insertion portion. The cartridge fuse 26 is positioned substantially on the central axis of the insertion portion 14a by the guide ribs 38 and held for movement in the axis of the insertion portion 14a. The terminal area 26a on the distal end side of the cartridge fuse 26 is in contact with the rear end of the head terminal 20.

As shown in FIG. 6, the connecting member 28 includes a spring portion 28a wound like a coil spring and a continuation portion 28b, which extends straight from a coil end of the spring portion on the cartridge fuse 26 side so as to be parallel to the spring portion. The spring portion 28a and the continuation portion 28b are integrally formed by forming a common wire rod of an electrically conductive metal, such as copper.

As shown in FIGS. 2 to 5, the spring portion 28a of the connecting member 28 is located in series with the cartridge fuse 26 between the cartridge fuse 26 and the fixed terminal 22. The front coil end of the spring portion 28a abuts one of the terminal areas 26a of the cartridge fuse, while the rear coil end abuts the fixed terminal 22. In this arrangement, the spring portion 28a urges the cartridge fuse 26 so that the head terminal 20 projects outward from the distal end of the insertion portion 14a and electrically connects the cartridge fuse 26 and the fixed terminal 22. Thus, the head terminal 20 is electrically connected to the power-source lead wire 17a through the cartridge fuse 26, the spring portion 28a, the fixed terminal 22, and the power source pattern of the PCB 24.

The continuation portion 28b of the connecting member 28 radially extends from the coil end of the spring portion 28a on the cartridge fuse 26 side. It is then bent at right angles and extends straight and parallel to the axis of the spring portion. The continuation portion 28b extends backward beyond the spring portion 28a. Further, a straight extending part of the continuation portion 28b extends opposite the reverse surface 24b side of the PCB 24 with a gap.

The extending end of the continuation portion 28b is electrically connected to the power source pattern of the PCB 24 through a harness 40. Thus, the head terminal 20 is electrically connected to the power-source lead wire 17a through the cartridge fuse 26, the continuation portion 28b of the connecting member 28, the harness 40, and the power source pattern of the PCB 24.

A through-hole 42 is formed in a side edge part of the PCB 24. The harness 40 has one end solder-connected to the rear end of the continuation portion 28b and the other end solder-connected to the power source pattern of the PCB 24. The harness 40 extends from the continuation portion 28b to the upper surface 24a side of the PCB 24 through the through-hole 42 of the PCB. Further, the harness 40 is led around the side edges of the PCB to the reverse surface 24b side of the PCB and soldered to the power source pattern.

Thus, the harness 40 is led around to the reverse and upper surface sides of the PCB 24 through the through-hole 42 of the PCB. Even if the continuation portion 28b moves longitudinally in response to extension or contraction of the spring portion 28a, therefore, a load that acts on a junction between the harness 40 and the power source pattern can be reduced to prevent breakage.

Since the harness 40 is connected to the extending end of the continuation portion 28b that extends beyond the spring portion 28a, moreover, it can never be caught by the spring portion when the spring portion extends and contracts. Thus, stable operation of the spring portion 28a can be maintained, and breakage of the harness 40 and the like can be prevented.

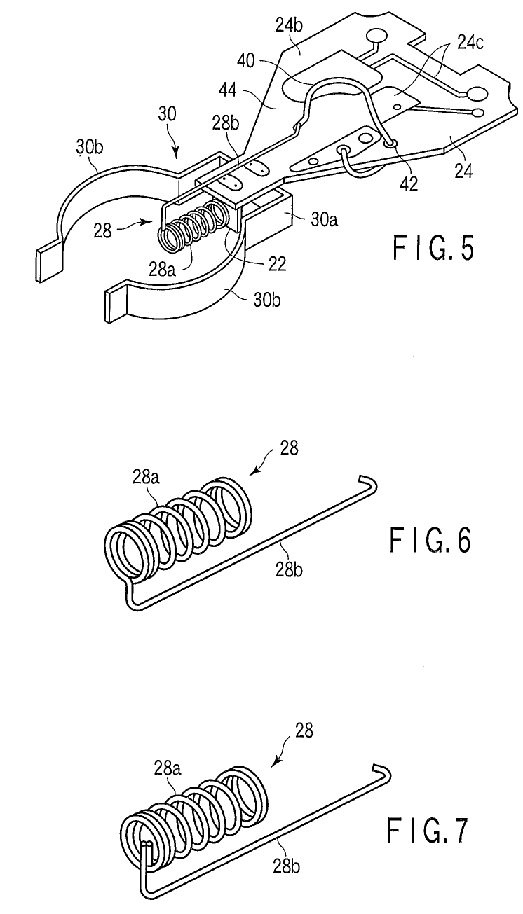

As shown in FIG. 5, that region of the reverse surface 24b of the PCB 24 which adjoins the continuation portion 28b of the connecting member 28 is covered by an insulating sheet 44. The insulating sheet 44 is situated between the PCB 24 and the continuation portion 28b and prevents short-circuiting between the wiring pattern of the PCB and the continuation portion 28b.

According to the car battery plug 10 constructed in this manner, when the insertion portion 14a of the plug housing 12 is fitted into the cigar lighter socket 50, the contact portions 30b of the ground contact 30 elastically contact the ground terminals on the inner surface of the lighter socket. At the same time, the head terminal 20 that movably projects from the distal end of the insertion portion 14a elastically contacts a power terminal 52 on the inner bottom surface of the cigar lighter socket 50 (see FIG. 3). Thus, the power terminal 52 is electrically connected to the power-source lead wire 17a of the power cord 17 through the head terminal 20, the cartridge fuse 26, the connecting member 28, the fixed terminal 22, the harness 40, and the power source pattern of the PCB 24.

As the insertion portion 14a is fitted into the cigar lighter socket 50, the head terminal 20 is pressed by the power terminal 52 and pushed into the insertion portion 14a. Then, the cartridge fuse 26 is axially moved by the head terminal 20, thereby pressing and compressing the spring portion 28a. Thereupon, the spring portion 28a produces an urging force and causes the cartridge fuse 26 to press the head terminal 20 elastically against the power terminal 52. Thus, the head terminal 20 can be securely brought into contact with the power terminal 52. At the same time, the head terminal 20, cartridge fuse 26, spring portion 28a, and fixed terminal 22 can be brought into full contact with one another and securely electrically connected.

A current supplied from the power terminal 52 is fed to the DVD drive unit 15 through the head terminal 20, the cartridge fuse 26, the connecting member 28, the fixed terminal 22, the harness 40, the power source pattern of the PCB 24, and the power-source lead wire 17a of the power cord 17. As the current flows through the connecting member 28, it diverges into currents that flow through the spring portion 28a and the continuation portion 28b, individually. The continuation portion 28b is substantially straight and shorter and lower in electrical resistance than the spring portion 28a. Therefore, a higher current flows through the continuation portion 28b than through the spring portion 28a. The level ratio of the current that flows through the spring portion 28a to the one that flows through the continuation portion 28b is, for example, 1 to 3. Thus, the current that flows through the spring portion 28a is about a quarter of that in the case where the continuation portion 28b is not included, so that heat generation by the spring portion 28a is suppressed.

If an overcurrent flows through the power terminal 52, on the other hand, a fuse of the thread portion 16 is blown, whereby the DVD drive unit 15 connected to the power cord 17 and the like can be protected. If the fuse is blown, the cartridge fuse 26 can be replaced with a new one by removing the insulating cap 18 from the insertion portion 14a of the plug housing 12 and taking out the cartridge fuse 26 together with the head terminal 20.

According to the car battery plug of the present embodiment, as described above, the connecting member that is located between the thread portion and the fixed terminal is composed of the spring portion in the form of a coil spring and the straight continuation portion. Therefore, the current that flows through the connecting member can be dispersed to the spring portion and the continuation portion, so that the current that flows through the spring portion can be reduced. Even when a relatively high current is supplied, therefore, the heat generation by the spring portion can be suppressed, so that the temperature of the entire plug housing can be prevented from increasing. Thus, there can be obtained a connector plug with improved reliability that never injures users.

While a certain embodiment of the invention has been described, this embodiment has been presented by way of example only, and is not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the materials, shapes, etc., of the component members are not limited to the foregoing embodiment but may be suitably changed as required. In the embodiment described above, the spring portion and the continuation portion of the connecting member are integrally formed by molding the same wire rod. Alternatively, however, a spring portion 28a and a continuation portion 28b may be formed of separate wire rods that are connected to each other by welding or the like, as shown in FIG. 7. In this case, the continuation portion 28b may be formed of a material with a conductance equal to or higher than that of the wire rod that forms the spring portion 28a. Alternatively, moreover, the continuation portion 28b may be formed of a rod wire that is larger in diameter than the continuation portion 28b. In either case, the current that flows through the spring portion can be further reduced, so that the heat generation by the spring portion can be suppressed additionally.

Furthermore, the spring portion of the connecting member may only have a function to urge the cartridge fuse and the head terminal at the least. Therefore, the spring portion may be formed of an electrically insulating material as well as an electrically conductive material. In this case, a supplied current flows through only the continuation portion of the connecting member, so that the heat generation by the spring portion can be prevented more securely. In this case, moreover, the fixed terminal need not be electrically connected to the power cord and is only expected to function as the retainer of the spring portion.

The continuation portion of the connecting member is not limited to the straight shape, but may alternatively be curved or partially bent within a plane parallel to the reverse surface of the PCB 24.

In connection with each of the foregoing embodiments, the connector plug has been described as a car battery plug. However, the present invention is also applicable to any other plug having its replaceable cartridge fuse 26 used as an overcurrent protection circuit component. The electronic device to which the connector plug is connected is not limited to the DVD drive unit, and the invention can be applied to various other electronic devices.

What is claimed is:

1. A connector plug comprising:
a plug housing attached to a power cord;
a head terminal movably attached to a distal end portion of the plug housing;
a fixed terminal arranged in the plug housing and electrically connected to the power cord;
a cartridge fuse located between the head terminal and the fixed terminal in the plug housing; and
a connecting member including a spring portion, which is wound like a coil spring and located between the cartridge fuse and the fixed terminal, urges the cartridge fuse toward the head terminal, and electrically connects the cartridge fuse and the fixed terminal, and a continuation portion, which extends from an end of the spring portion on the cartridge fuse side, extends straight or in a curve, and is electrically connected to the power cord.

2. A connector plug according to claim 1, wherein the spring portion and the continuation portion of the connecting member is formed integrally from a common wire rod.

3. A connector plug according to claim 1, wherein the continuation portion is formed of a material with a conductance equal to or higher than that of a wire rod which forms the spring portion and is fixed to the spring portion.

4. A connector plug according to claim 1, wherein the continuation portion extends straight and parallel to an axis of the spring portion after radially extending from the end of the spring portion on the cartridge fuse side.

5. A connector plug according to claim 1, which further comprises a printed circuit board arranged in the plug housing and connected to the power cord, and wherein the fixed terminal is mounted on the printed circuit board and the continuation portion is electrically connected to the printed circuit board through a harness.

6. A connector plug according to claim 5, wherein the fixed terminal is formed of an electrically conductive plate, which is fixed on the printed circuit board and electrically connected to a pattern of the printed circuit board.

7. A connector plug according to claim 5, wherein the continuation portion faces one surface of the printed circuit board with a gap, the printed circuit board has a through-hole, and the harness includes one end portion connected to the continuation portion and the other end portion connected to the printed circuit board on the one surface side of the printed circuit board, extends from the continuation portion to the other surface side of the printed circuit board through the through-hole in the printed circuit board, and is led around a side edge of the printed circuit board to the other end portion.

8. A connector plug according to claim 7, which further comprises an insulating sheet which is situated between the printed circuit board and the continuation portion and covers the one surface of the printed circuit board.

9. A connector plug according to claim 1, wherein the connector plug is a car battery plug configured to be fitted and connected to a cigar lighter socket.

10. A connector plug comprising:
a plug housing attached to a power cord;
a head terminal movably attached to a distal end portion of the plug housing;
a fixed spring retainer arranged in the plug housing so as to face the head terminal;
a cartridge fuse located between the head terminal and the spring retainer in the plug housing; and
a connecting member including a spring portion, which is wound like a coil spring and located between the cartridge fuse and the spring retainer and urges the head terminal outward from the distal end portion of the plug housing through the cartridge fuse, and a continuation portion, which extends from an end of the spring portion on the cartridge fuse side, extends straight or in a curve, and is electrically connected to the power cord.

11. A connector plug according to claim 10, wherein the spring portion is formed of an insulating material.
